(19) United States
(12) Patent Application Publication
(10) Pub. No.: US 2006/0248794 A1
(43) Pub. Date: Nov. 9, 2006

(54) Method for repairing, regrassing or establishing a green

(76) Inventors: Wendy Van Paridon-Bakker, EJ Wijdenes (NL); Stuart William Akers, Gilroy, CA (US)

Correspondence Address: NATH & ASSOCIATES, 112 South West Street, Alexandria, VA, 22314, US

(21) Appl. No.: 11/121,177

(22) Filed: May 4, 2005

(51) Int. Cl. A01G 23/10

(52) U.S. Cl. 47/10

(57) ABSTRACT

The invention provides a method for repairing, regrassing or establishing a green, which method comprises incorporating in or applying at the soil surface of the green to be repaired, regrassed or established a flowable primed grass seed which displays physiological activity. The invention also relates to the use of primed grass seed to repair, regrass or establish a green which grass seed displays physiological activity. Further, the invention provides a flowable primed grass seed displaying physiological activity.

The present invention relates to a method for rapidly repairing, regrassing or establishing a green, the use of a particular grass seed to rapidly repair, regrass or establish a green, and a flowable primed grass seed which displaying physiological activity.

In the sports and leisure industry there is a need for well-maintained high quality greens, such as golf greens, cricket green including pitches, bowling greens, tennis courts, home lawns, parks and so on. Especially in sports, the greens can be damaged relatively easy, which often make them unsuitable for continued use. Hence, there is clear demand for equipment and processes to repair greens very quickly, allowing the green in question to be used again without any unduly delay.

It is known to repair damaged greens or greens that otherwise are in need of repair with grass seed that has been primed. The term “priming” is well understood and defines a pre-sowing hydration treatment of seeds, which is carried out in the presence of restricted amounts of water with or without additional chemicals. Priming is designed to increase germination speed, germination uniformity and also to break all kinds of dormancies. Seed does not sprout during priming, but when priming is completed the primed seed is very close to that end point of germination. Conventionally, once the priming process is completed, the seed is dried to the appropriate low moisture content that facilitates a sufficiently long shelf life. However, a considerable drawback of conventional primed and dried grass seeds is that they do not allow for as rapid repair since such primed and dried seed must re-imbibe water to re-initiate physiological activity within the seed which process takes a relatively long period of time. Therefore, conventionally primed and dried grass seed does not allow a rapid repair of a green.

Object of the present invention is to provide a method, which enables a very rapid repair of a green, especially so-called high value greens such as golf greens.

Surprisingly, it has now been found that this can be realised when use is made of a primed grass seed, which is flowable and displays physiological activity.

Accordingly, the present invention relates to a method for repairing, regrassing or establishing a green, which method comprises incorporating in or applying at the soil surface of the green to be repaired, regrassed or established a flowable primed grass seed which displays physiological activity.

The primed grass seed to be used in accordance with the present invention can either be incorporated in the soil of the surface of the green to be repaired or just applied at the surface of the soil surface. Preferably, the primed grass seed is incorporated in the soil surface of the green to be repaired. Such incorporation of the grass seed into greens can suitably be established by means of any known planting method. Preferably, such incorporation is established by means of a drop seed planter after which a rake can be applied to mix the grass seed with loose soil on the surface of the green to be repaired. Subsequently, a light cover of an appropriate material such as redwood mulch can be applied, after which the green can be watered.

In order to avoid any misunderstanding it is noted that the flowable primed grass seed displays physiological activity before it is incorporated in or applied at the soil of the green to be repaired, regrassed or established. In other words, the physiological activity developed within the seed during the priming process was not lost since the seed was not dried back to a low moisture content.

The primed grass seed to be used in accordance with the present invention is flowable, i.e. it is substantially surface dry. In other words, the seed particles can freely move with respect to each other. This can suitably be established by partial dehydration of the freshly primed seed or by applying a coating on the freshly primed seed. Preferably, the entire surface of the individual seeds is dry. The use of a flowable primed grass seed that displays physiological activity enables a surprisingly rapid repair of a green.

The flowable primed grass to be used in accordance with the present invention is obtained by subjecting a grass seed to a priming process. In case the freshly primed seed so obtained is flowable, it can advantageously immediately be used to repair, regrass or establish a green. Alternatively, the freshly primed grass seed may need to be dried partially before it can be used repair, regrass or establish a green. The flowable primed grass seed to be used in accordance with the present can also suitably be stored at low temperature for a certain amount of time before it is use to repair, regrass or establish a green. The flowable primed grass seed to be used in accordance with the present invention will have a relatively high water content, but generally no germination will have yet occurred, i.e. the seed will display very few, if any radicles. Suitably, less than 1% of the flowable primed grass seed displays radicles. Preferably, less than 0.5% of the flowable primed grass seed displays radicles. In a particular attractive embodiment the flowable primed grass seed displays in essence no radicles. This unique combination of high water content and absence of radicles allows for the surprisingly rapid repair, regrass treatment or establishment of a green, which is especially advantageous in respect of golf greens that need to be used almost continuously. Preferably, the flowable primed grass seed does not display any radicles.

The grass seed to be used in accordance with the present invention displays improved earliness, as well as an improved uniformity of final stand at especially low temperatures (below 20° C.).

Suitably, the grass seed to be primed has a water content in the range of from 5 to 15% wt, based on total weight of seed. Preferably, the primed grass seed has a water content in the range of from 25 to 50% wt, based on total weight of seed. The skilled person will understand that the water content to be obtained will depend on the amount of water to be used in the priming process and/or the length of time during which the grass seed is subjected to the priming process and/or the grass species which is primed and or the used chemicals. Hence, the skilled person will know how to obtain primed seeds having a particular water content.

A variety of known priming processes can be used in accordance with the present invention. Such priming processes include the use of osmopriming, solid matrix priming, drum priming or any other priming method.

Suitably, the primed grass seed has such a water content that the ratio of the water contents of the primed grass seed (A) and the raw untreated grass seed to be primed (B) is greater than 1 (A/B). Preferably, A/B is in the range of from 1.6 to 10, more preferably in the range of from 2 to 5, more preferably in the range of from 2.5 to 4. Such grass seeds allow for a very attractive and swift repair of greens such as golf greens, cricket green including pitches, bowling greens, tennis courts, home lawns, and parks, which is especially of importance for greens that are very frequently used such as golf greens. Hence, the method is preferably carried out to repair a golf green.

After the primed grass seed to be used in accordance with the present invention has been prepared, it can very quickly be used to repair, regrass or establish a green. Preferably, the grass seed is used within 100 hours after the priming process has been completed. More preferably, the primed grass seed is used within 24 hours after the priming process has been completed. This period will depend on the temperature of storage of the primed grass seed, as well as its water content. At low temperature (5° C.) the time to use the primed seeds can be elongated. The time for use to repair the green can be increased by shortening the priming period.

In accordance with the present invention a wide variety of grass seeds, within the plant order of Poales specifically within the familie Poaceae can be used. This family contain over 12000 species. Suitable types of grass seeds include those selected from the group consisting of Poa, Lolium, Dactylis, Festuca, Deschampsia, Koeleria, Agrostis, Cynodon, Zoysia, Buchlo, Axonopus, Eremchloa, Paspalum and Stentaphrum.

Very attractive results are obtained when the grass seed comprises Poa pratensis, Deschampsia flexuosa, Lolium perrenne, Agrostis capillaris tenuis or Festuca arundinacea.

Also mixtures of two or more types of grass seed can be used in accordance with the present invention

The primed grass seed may comprise in any known additives that are usually used to improve the quality of the green. Suitable additives include fungicides, insecticides, bactericides, nematicides, biocides and even herbicides (weed killers). In addition, growth promotive additives such micro and/or macro nutritients, hormones, bioenhancers, gen-elicitors, plant or seaweed extracts, such as neem extracts, peroxides or even benificial micro organisms such as Bacillus, Trichoderma or Pseudomonas can be used. Such additives can suitably be present in an amount in the range of from 0.001 to 100% wt, based on total weight of seed.

Suitably, the primed grass can be coated before it is used to repair a green. The coating can be established by means of any of the known coating processes that are used for that purpose. This coating layer can improve the flowability and therefore the plantability of the primed seeds. Suitable coating methods include film coating, encrusting or pelleting. Preferably, the coating of the primed grass seed is established by an encrusting method. Such a coating can suitably be present in an amount in the range of from 0.1 to 1000% wt, based on total weight of seed.

In a particular attractive embodiment of the present invention, the priming process is carried out in a transferable unit (e.g. a truck), enabling the grass seed to be used for repairing, regrassing or establishing a green within just a few hours after the priming process has been completed.

The present invention also relates to the use of primed grass seed for repairing, regrassing or establishing a green. The grass seed may be any of the type of grass seeds described above, and these seeds can be primed using the type of processes indicated before.

The present invention also relates to a flowable primed displaying physiological activity. Preferably, the flowable primed grass seed displays physiological activity to the extent that it is completely ready for germination, but very little, if any, radicle protrusion has taken place. Preferably, said primed grass seed has a water content in the range of from 25 to 50% wt, based on total weight of seed.

The flowable primed grass seed in accordance with the present invention can be used to repair, regrass or establish a green.

Hence, the present invention provides a method for repairing a green, which method comprises incorporating in or applying at the soil surface of the green to be repaired a flowable primed grass seed, which displays physiological activity.

In addition, the present invention also provides a method for regrassing a green, which method comprises incorporating in or applying at the soil surface of the green to be repaired a flowable primed grass seed, which displays physiological activity. The flowable primed grass seed in accordance with the present invention can be used to regrass an existing green completely in case the turf has been removed from the soil. A particular advantage of the flowable primed grass seed of the present invention that it allows over time the complete replacement on a green of one type of grass by another type of grass, which obviously saves a lot of time (and money), which is especially of importance of frequently used greens such as golf greens.

Further, the present invention also provides a method for establishing a green, which method comprises incorporating in or applying at the soil surface of the green to be repaired a flowable primed grass seed, which displays physiological activity. In other words, the present invention allows for the establishment of a green starting just from bare soil. Also, this embodiment is very attractive since a very rapid building of a green can be realised.

### EXAMPLES

### Example 1

A method according to the present invention was carried out as follows. 4.1 kg of a Perennial rye grass blend having a water content of 10.5% wt, based on total weight of seed were subjected to a priming process by contacting said grass seed with a solution of 0.2% KNOS. at a temperature of 20° C. during 4.75 days in one 83 litre drum. After the priming process was completed the primed grass seed having a water content of 38.01% wt, based on total weight of seed, was immediately recovered and stored in a container kept at 15° C. Four hours later the grass seed so obtained was planted in a green in need of repair. The seed was planted at a rate of ½ lb per plot (plots were 3 feet by 6 feet=18 sq feet). Each plot was planted within 15 minutes using a seed planter. Then a rake was used to mix the seed with loose soil on the surface and light cover of redwood mulch was applied, after which the plot was thoroughly watered. For reasons of comparison, grass seed that had been primed and dried in a conventional manner was also planted, as well as seed that had not been primed (untreated seed).

After 3 days green grass sprouts came up through the redwood mulch in the plot where freshly primed seed in accordance with the present invention had been planted. It was 2 days later before sprouts were seen in the plot with the conventionally primed and dried seed, as well as the plot with the non-primed seed.

The germination of each of these three seeds was also conducted, using a thermogradient table. In this test a temperature gradient was formed on a table such that 10 plantings could be made into 10 different temperatures (16-36° C.). Once planted, the seeds were germinated in the dark (see Tables 1 and 2 below).

### Example 2

A method according to the present invention was carried out as follows. 92 kg of Bent Grass (Seaside II) having a water content of 10.96% wt, based on total weight of seed, was subjected to a priming process by contacting said grass seed with a solution of 0.2% KNO₃ at a temperature of 20° C. during 7 days in eight 400 litre drums. After the priming process was completed the primed grass seed having a water content of 32.5% wt, based on total weight of seed, was immediately recovered and stored in a container kept at 15° C. Two hours later the freshly primed grass seed was planted on a green.

The purpose of this planting was to replace the Poa grass that is currently present on the green with bent grass. The primed bent grass seed was planted into the green that is currently populated with Poa. It is expected that the will be populated with Bent grass up to 100% within a year.

From the results, shown in Tables 1 and 2, it will be clear that the method according to the present invention constitutes a significant improvement over the method wherein use is made of a primed grass which has subsequently be subjected to a drying step, resulting in a grass seed having a low water content.

TABLE 1

| | Temp. range ° C. | | | | | | | | | |
|---|---|---|---|---|---|---|---|---|---|---|
| Treatments | 16-18 | 18-20 | 20-22 | 22-24 | 24-26 | 26-28 | 28-30 | 30-32 | 32-34 | 34-36 |
| Primed not dried | 67 | 72 | 79 | 82 | 82 | 85 | 82 | 76 | 70 | 18 |
| Primed & dried | 6 | 24 | 36 | 36 | 64 | 61 | 70 | 64 | 42 | 0 |
| untreated seed | 0 | 3 | 12 | 39 | 42 | 42 | 42 | 46 | 12 | 0 |

Thermogradient test—Sprout counts made after 2 days. Thermogradient range is from 16° C. to 36° C.

TABLE 2

| | Temp. range ° C. | | | | | | | | | |
|---|---|---|---|---|---|---|---|---|---|---|
| Treatments | 16-18 | 18-20 | 20-22 | 22-24 | 24-26 | 26-28 | 28-30 | 30-32 | 32-34 | 34-36 |
| Primed not dried | 85 | 85 | 88 | 76 | 85 | 88 | 88 | 33 | 24 | 0 |
| Primed & dried | 12 | 65 | 76 | 70 | 82 | 79 | 94 | 76 | 15 | 0 |
| untreated seed | 9 | 70 | 91 | 91 | 94 | 85 | 88 | 58 | 0 | 0 |

Thermogradient test—Counts of seedlings with a visible coleoptile were made after 5 days on the table. TG range is from 16° C. to 36° C.

1. A method for repairing, regressing or establishing a green, which method comprises incorporating in or applying at the soil surface of the green to be repaired, regressed or established a flowable primed grass seed, which displays physiological activity.

2. A method according to claim 1, wherein the grass seed is incorporated in the soil surface of the green to be prepared.

3. A method according to claim 1, wherein the primed grass seed is obtained by subjecting a grass seed to a priming process after which the primed grass so obtained is immediately recovered for use to repair, regrass or establish a green or the primed grass so obtained is partially dehydrated before it is recovered for use to repair, regrass or establish a green.

4. A method according to claim 1, wherein the primed grass seed has a water content in the range of from 25 to 50% wt, based on total weight of seed.

5. A method according to claim 1, wherein the ratio of the water contents of the primed grass seed (A) and the grass seed to be primed (B) is greater than 1 (A/B).

6. A method according to claim 5, wherein A/B is in the range of from 1.6 to 10.0.

7. A method according to claim 6, wherein A/B is in the range of from 2 to 4.

8. A method according to claim 1, wherein less than 1% of the flowable primed grass seed displays radicles.

9. A method according to claim 3, wherein the grass seed is used to repair the green within 100 hours after the priming process has been completed.

10. A method according to claim 9, wherein the grass seed is used to repair the green within 24 hours after the priming process has been completed.

11. A method according to claim 1, wherein the primed grass seed has been coated.

12. A method according to claim 1, wherein an additive has been added to the primed grass seed.

13. A method according to claim 1, wherein the grass seed is selected from the group consisting of Poa, Lolium, Dactylis, Festuca, Deschampsia, Agrostis, Koeleria, Agrostis, Cynodon, Zoysia, Buchlo, Axonopus, Eremchloa, Paspalum and Stentaphrum.

14. A method according to claim 13, wherein the grass seed comprises, Poa pratensis, Deschampsia flexuosa, Lolium perrenne, Agrostis capillaries tenuis or Festuca arundinacea.

15. A method according to claim 1, wherein the green is a golf green.

16. Use of a flowable primed grass seed that displays physiological activity to repair, regrass or establish a green.

17. A flowable primed grass seed displaying physiological activity.
